(19) United States
(12) Patent Application Publication
(10) Pub. No.: US 2018/0192486 A1
(43) Pub. Date: Jul. 5, 2018

(54) FLYBACK BIFILAR/MULTIFILAR SYMMETRIC TRANSFORMER

(71) Applicant: General Electric Company, Schenectady, NY (US)

(72) Inventors: Shimon Khananshvili, Lod (IL); Michael Manelis, Lod (IL); Ramanujam Ramabhadran, Niskayuna, NY (US)

(21) Appl. No.: 15/399,324

(22) Filed: Jan. 5, 2017

(51) Int. Cl. H05B 33/08; H02M 3/335; H02M 1/44; H02M 1/08; H01F 38/42; H01F 27/32; H01F 41/069

(52) U.S. Cl. CPC H05B 33/0815; H02M 3/33507; H02M 1/44; H02M 2001/0048; H01F 38/42; H01F 27/325; H01F 41/069; H02M 1/08

(57) ABSTRACT

Methods and systems useful in reducing leakage inductance in a flyback transformer. By way of example, a flyback transformer includes a bobbin. The flyback transformer includes primary windings and secondary windings configured to enter a first side of the flyback transformer, to wrap around the bobbin of the flyback transformer to form a bifilar coil or a multifilar coil, and to exit the flyback transformer on the first side of the flyback transformer.

### BACKGROUND OF THE INVENTION

The subject matter disclosed herein relates to transformers, and more particularly, to systems and methods of constructing a flyback transformer.

Power systems may use transformers to convert power from a power source into power suitable to deliver to a load. For example, flyback transformers may be used to increase voltages, decrease voltages, or provide galvanic isolation between the power source and the load. Further, flyback transformer may be used in circuits to provide output power of a different waveform than received power. For instance, flyback transformers may be used to drive light emitting diodes (LEDs) due to the output power which it provides. However, physical characteristics of the flyback transformer may cause losses in power delivered to the LEDs, thereby reducing efficiency of the power system.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a flyback transformer includes a bobbin, and primary windings and secondary windings configured to enter a first side of the flyback transformer, to wrap around the bobbin of the flyback transformer to form a bifilar coil or a multifilar coil, and to exit the flyback transformer on the first side of the flyback transformer.

In a second embodiment, a method includes wrapping primary windings and secondary windings around a bobbin such that a first part of the primary windings is overlapped by a second part of the primary windings and a first part of the secondary windings is overlapped by a second part of the secondary windings, and wherein the primary windings are wrapped adjacent to the secondary windings.

In a third embodiment, a power system includes a flyback transformer, including a bobbin of a flyback transformer, and primary windings and secondary windings wrapped around a bobbin of the flyback transformer to form a bifilar coil or a multifilar coil in which the primary windings are wrapped adjacent to the secondary windings and in parallel with the secondary windings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a power system that uses a flyback transformer to provide power to an light emitting diode (LED) load, in accordance with an embodiment;

FIG. 2 is a schematic diagram of the flyback transformer of FIG. 1 having terminals of primary windings and secondary windings on a side, in accordance with an embodiment; and

FIG. 3 is a cross-sectional view of the flyback transformer of FIG. 1 having the primary windings and the secondary windings adjacent and in parallel to one another, in accordance with an embodiment.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The systems and methods described below relate generally to flyback transformers which may be used in a variety of applications in which a waveform of power received by the flyback transformer is different from power output by the flyback transformer. For example, a flyback transformer may be used to provide power from a power source to a load, such as light emitting diodes (LEDs). The flyback transformer may receive power while coupled to a DC power supply via closing of a switch, for instance. In one embodiment, the flyback transformer may store energy in the flyback transformer while the switch is closed. Upon opening of the switch, the energy stored in the flyback transformer may induce a voltage in secondary windings to provide power to the LEDs after the primary side stops receiving power.

However, construction of the flyback transformer may introduce leakage inductance, electromagnetic interference, or heat. For example, the flyback transformer may be constructed with primary windings and secondary windings of the flyback transformer with improper magnetic linking resulting in leakage inductance. These physical characteristics may result in decreased efficiencies of the flyback transformer. As such, systems and methods of fabricating flyback transformers that reduce leakage inductance, electromagnetic interference, and heat are desirable.

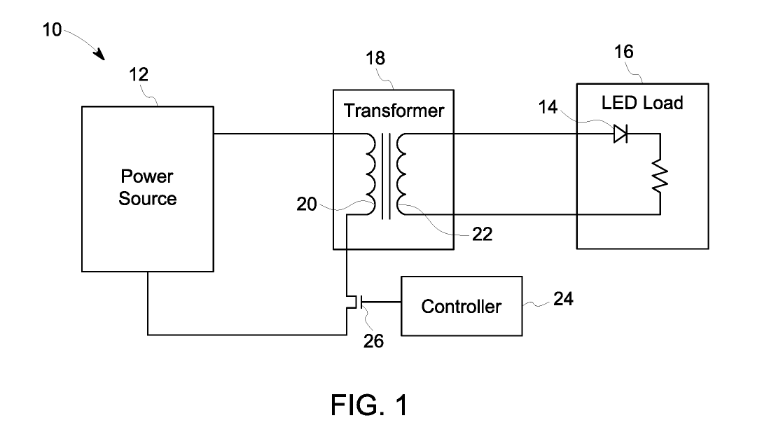

FIG. 1 is a block diagram of a power system 10 having a power source 12 that provides power to one or more light emitting diodes (LEDs) 14 of an LED load 16 via a flyback transformer 18. The flyback transformer 18 may include primary windings 20 electrically coupled to the power source 12 and secondary windings 22 electrically coupled to one or more LEDs 14 of the LED load 16. In some embodiments, a diode may be electrically coupled between the secondary windings 22 and the LED 14 to prevent current flow in an opposite direction.

The power system 10 may include a controller 24 electrically coupled to a gate of a switch 26. The controller 24 may include any suitable circuitry to control the switch 26. For example, the controller 24 may include a processor operatively coupled to a memory. The memory may store processor-executable instructions for the processor to execute, such as instructions to send signals to the switch 26 to open or close the switch 26 to connect or disconnect the flyback transformer 18 with the power source 12. The power source 12 may provide direct current (DC) power to the primary windings 20 to cause energy to increase in a core of the flyback transformer 18. The controller 24 may send a signal to the switch 26 to open the switch 26. Upon opening the switch 26, energy in the core due to the changing current in the primary windings 20 may induce a voltage in the secondary windings 22 to deliver power to the LEDs 14. The flyback transformer 18 may step up voltages or step down voltages delivered to the LEDs 14 and/or provide galvanic isolation between the power source 12 and the LEDs 14. While the DC power source 12 is used as here as an example, in other embodiments, AC power may be used (e.g., to power components of the LED driver 16, 20, 24, and 26).

The higher the efficiency of the transformer 18, the more power generated by the power source 12 that is delivered to the load 14. However, as mentioned above, the construction of the flyback transformer 18 may introduce leakage inductance causing reduced efficiency of the flyback transformer 18. For example, asymmetry between the primary windings 20 and the secondary windings 22 may result in increased leakage inductance. As described below, the flyback transformer 18 may be constructed in a manner that reduces leakage inductance, thereby improving efficiency and reducing losses.

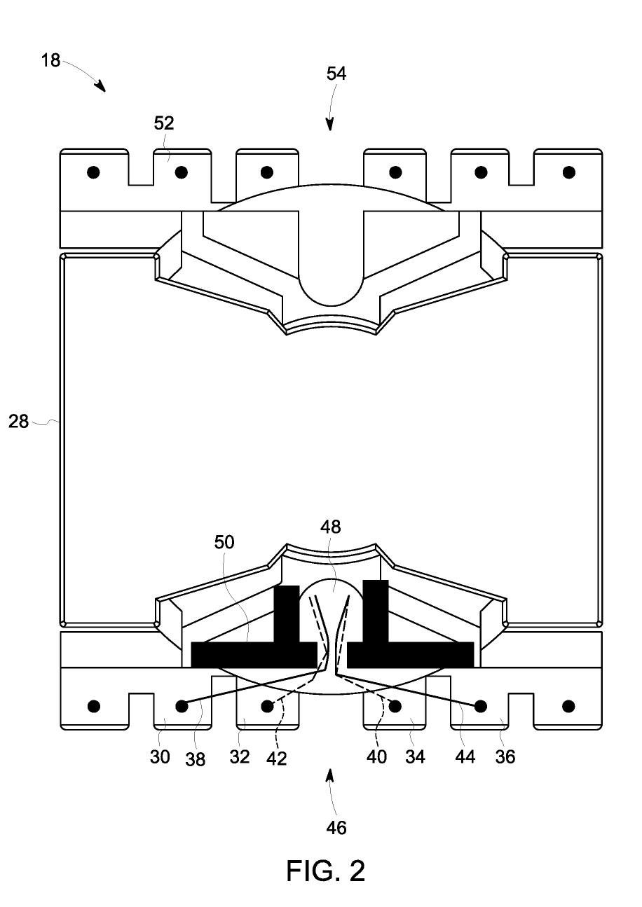

FIG. 2 is a schematic diagram of the flyback transformer 18 having primary windings 20 and secondary windings 22 that use triple-insulated wire to allow the primary windings 20 and secondary windings 22 to be bifilar or multifilar, or closely spaced (e.g., adjacent) and in parallel. That is, each of the primary windings 20 and secondary windings 22 may include two (i.e., “bifilar”) or more (i.e., “multifilar”) closely spaced, parallel wires wherein each of the individual wires of the secondary windings 22 and primary windings are individually insulated with a suitable insulative wrap, such as triple-insulated wire. For example, three layers of insulation may be placed over a conductor within the primary windings 20 and a conductor within the secondary windings 22 to provide sufficient insulation such that the primary windings 20 and secondary windings 22 may be wrapped adjacent to each other without a layer of insulation tape therebetween. By using the triple-insulated wire to closely space the primary windings 20 with the secondary windings 22, leakage inductance of the flyback transformer 18 may be reduced.

The flyback transformer 18 includes a bobbin 28 that holds the primary windings 20 and the secondary windings 22 and secures the primary windings 20 and secondary windings 22 to the core within the flyback transformer 18. The bobbin 28 may be constructed of any suitable material, such as plastic. The bobbin 28 may include one or more pins 30, 32, 34, and 36 in which to couple the primary windings 20 and the secondary windings 22. For example, the primary windings 20 may include terminals 38 and 40 coupled to the pins 30 and 34, and the secondary windings 22 may include terminals 42 and 44 coupled to pins 32 and 36 to enable the terminals 38, 40, 42, and 44 to be electrically coupled to other components or circuitry, as described above. The pin layout is described herein simply as an example, and the terminals 38, 40, 42, and 44 may be coupled to the pins in any other suitable pattern.

From the pins 30 and 32, the primary windings 20 and the secondary windings 22 may enter an opening 48 on a first side 46 of the bobbin 28, wrap around a bobbin 28 to form a bifilar coil or a multifilar coil, as described below, and exit the opening 48 on the first side 46 to the pins 34 and 36. By forming a bifilar coil with the primary windings 20 and the secondary windings 22 and having the windings enter and exit the same opening 48 on the first side 46, the flyback transformer 18 may have reduced leakage inductance due to the close coupling between the primary windings 20 and the secondary windings 22.

The flyback transformer 18 may include a guide 50 that ensures the primary windings 20 are secured in close proximity to the secondary windings 22 until the primary windings 20 and the secondary windings 22 enter or exit the opening 48 towards the pins 30, 32, 34, and 36. By having the guide 50 hold the primary windings 20 closely to the secondary windings 22, leakage inductance is minimized as the primary windings 20 and the secondary windings 22 enter or exit the opening 48 without sacrificing clearance between each of the terminals. In some embodiments, the guide 50 may be incorporated as part of the bobbin 28. In other embodiments, the guide 50 may be a separate part from the bobbin 28 and secured to the bobbin 28 in any suitable manner.

The flyback transformer 18 may include one or more pins 52 on a second side 54 of the flyback transformer 18 opposite the first side 46. The one or more pins 52 on the second side 54 may receive terminals of auxiliary windings other than the primary windings 20 and the secondary windings 22. For example, the auxiliary windings may supply a bias voltage, provide additional step down voltages, sense output voltages to a winding, shut down a portion of the flyback transformer 18, or any other desired windings that may not be tightly coupled to the transformer 18 as compared to the primary windings 20 and secondary windings 22. While the auxiliary windings are described as being coupled on the second side 54, in some embodiments, the auxiliary windings may be coupled on the first side 46.

As described below, the primary windings 20 and the secondary windings 22 include triple-insulated wire to allow the primary windings and secondary windings to be closely spaced (e.g., adjacent) and in parallel resulting in reduced leakage inductance. By using triple-insulated wire, the primary windings 20 and the secondary windings 22 may form a bifilar or multifilar coil that results in magnetic energy better transferring to the secondary windings 22.

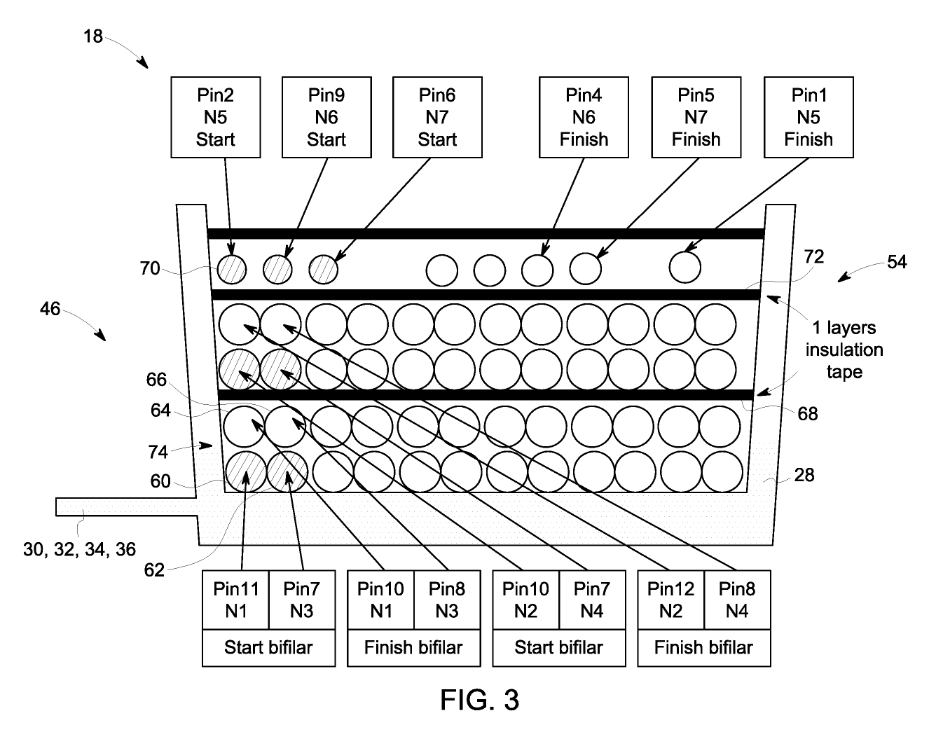

FIG. 3 is a cross-sectional view of the flyback transformer 18 having the primary windings 20 and the secondary windings 22 wrapped around the bobbin 28 to form a bifilar coil or a multifilar coil. For example, the primary windings 20 and secondary windings 22 may enter the bobbin 28 from the pins 30, 32, 34, and 36 and wrap around the bobbin 28 such that a first part 60 of the primary windings 20 is arranged adjacent and in parallel to a first part 62 the secondary windings 22. The primary windings 20 and secondary windings 22 are wrapped around the bobbin 28 such that a second part 64 of the primary windings 20 and a second part 66 of the secondary windings 22 overlaps the first part 60 of the primary windings 20 and the first part 62 of the secondary windings 22, respectively. That is, an end of the primary windings 20 overlaps a start of the primary windings 20, and an end of the secondary windings 22 overlaps a start of the secondary windings such that the primary windings 20 and the secondary windings 22 are wrapped in a symmetrical pattern and adjacent to one another. The primary windings 20 and the secondary windings 22 form a bifilar coil 74 in which the primary windings 20 and the secondary windings 22 are closely spaced and in parallel on top of one another and secured within the bobbin 28. While the bifilar coil 74 pattern is shown in FIG. 3, this is simply meant as an example and the primary windings 20 and the secondary windings 22 may form multifilar coils depending on a turn ratio of the flyback transformer 18.

As noted above, each of the primary windings 20 and the secondary windings 22 may include triple insulated wire. That is, a conductor within first part 60 of the primary windings 20 may be covered within three layers of insulation and a conductor within the first part 62 of the secondary windings 22 may be covered within three layers of insulation to enable the primary windings 20 and the secondary windings 22 to be placed adjacent to one another (e.g., as opposed to placing the secondary windings 22 above insulation layer 68).

Upon wrapping the primary windings 20 and the secondary windings 22 around the bobbin 28, the primary windings 20 and the secondary windings 22 may exit the flyback transformer 18 through the opening 48 on the first side 46. By wrapping the primary windings 20 and the secondary windings 22 around the bobbin 28 to form the bifilar coil 74, by having the primary windings 20 and the secondary windings 22 enter and exit the flyback transformer 18 on the same side, and/or by maintaining the primary windings 20 adjacent to the secondary windings 22 via the guide 50 as the primary windings 20 and secondary windings 22 enter and exit the bobbin 28, the leakage inductance due to the placement of the primary windings 20 and the secondary windings 22 may be reduced or minimized. For example, in some embodiments, the construction using the symmetry and/or the guide 50 may reduce leakage inductance to approximately 0.1%-0.5% (e.g., 0.13%-0.3%).

Depending on the number of coils and number of layers of windings, the flyback transformer 18 may include insulation tape 68 to secure the primary windings 20 and the secondary windings 22 within the flyback transformer 18 in the symmetrical pattern. Further, as mentioned above, auxiliary windings 70 may be wrapped around an outer layer (e.g., after insulation tape 72) and may be secured to the bobbin 28 using an additional layer of insulation tape 74. Note that, while an embodiment is described with respect a transformer, the method of wrapping windings may be extended to coupled inductors and implementations in other topologies, which may be adapted by those skilled in the art.

Technical effects of the invention include a flyback transformer constructed with primary windings and secondary windings symmetrically wrapped around a bobbin in a bifilar manner. The flyback transformer may include an opening on a first side of the flyback transformer. The primary windings and the secondary windings may enter the bobbin through the opening, wrap around the bobbin in a symmetrical manner, and exit the bobbin through the same opening on the first side. The symmetry and close coupling between the primary windings and the secondary windings may result in reduced leakage inductance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A flyback transformer, comprising:
a bobbin; and
primary windings and secondary windings configured to enter a first side of the flyback transformer, to wrap around the bobbin of the flyback transformer to form a bifilar coil or a multifilar coil, and to exit the flyback transformer on the first side of the flyback transformer.

2. The flyback transformer of claim 1, wherein each of the primary windings and the secondary windings comprise triple-insulated wire that insulates conductors within each of the primary windings and the secondary windings to allow the primary windings and secondary windings to be adjacent and in parallel with one another.

3. The flyback transformer of claim 1, comprising a guide on the first side of the flyback transformer, wherein the guide is configured to maintain the primary windings adjacent to the secondary windings as the primary windings and the secondary windings enter and exit the flyback transformer.

4. The flyback transformer of claim 1, wherein a start of the primary windings is overlapped by an end of the primary windings, and wherein a start of the secondary windings is overlapped by an end of the secondary windings.

5. The flyback transformer of claim 4, wherein the ends of the primary windings and the secondary windings are insulated by insulation tape to secure the primary windings and the secondary windings in a symmetrical pattern.

6. The flyback transformer of claim 1, wherein the primary windings and secondary windings form a bifilar coil that is closely spaced and in parallel such that inductance of the primary windings is between 0.13% and 0.3% of output power.

7. The flyback transformer of claim 1, comprising auxiliary windings wrapped around an outer layer of the flyback transformer.

8. The flyback transformer of claim 7, wherein the auxiliary windings enter and exit the flyback transformer on a second side of the flyback transformer opposite the first side.

9. A method, comprising:
wrapping primary windings and secondary windings around a bobbin such that a first part of the primary windings is overlapped by a second part of the primary windings and a first part of the secondary windings is overlapped by a second part of the secondary windings, and wherein the primary windings are wrapped adjacent to the secondary windings.

10. The method of claim 9, comprising coupling the primary windings and the secondary windings to pins on a side of the bobbin.

11. The method of claim 9, comprising overlapping the primary windings and the secondary windings with auxiliary windings on a periphery of the bobbin.

12. A power system, comprising:
a flyback transformer, comprising:
a bobbin of a flyback transformer; and
primary windings and secondary windings wrapped around a bobbin of the flyback transformer to form a bifilar coil or a multifilar coil in which the primary windings are wrapped adjacent to the secondary windings and in parallel with the secondary windings.

13. The power system of claim 12, wherein the bobbin is a fabricated part configured to secure primary and secondary windings within the bobbin.

14. The power system of claim 12, wherein the primary windings and secondary windings are configured to:
enter the flyback transformer on a first side of the bobbin; and
exit the flyback transformer on the first side of the flyback transformer.

15. The power system of claim 14, wherein the primary windings and secondary windings are configured to enter and exit an opening on the first side of the bobbin.

16. The power system of claim 12, wherein each of the primary windings and the secondary windings comprise triple-insulated wire that insulates conductors within each of the primary windings and the secondary windings to allow the primary windings and secondary windings to be adjacent to one another and in parallel.

17. The power system of claim 12, comprising light emitting diode circuitry configured to receive power from the secondary windings of the flyback transformer to emit light.

18. The power system of claim 12, wherein the flyback transformer comprises insulation tape to secure the primary windings and the secondary windings in a symmetrical pattern.

19. The power system of claim 12, wherein the flyback transformer comprises a guide configured to maintain the primary windings adjacent to the secondary windings as the primary windings and the secondary windings enter and exit the flyback transformer.

20. The power system of claim 12, comprising pins on an exterior of the bobbin configured to couple to terminals of the primary windings and terminals of the secondary windings on a first side of the flyback transformer.
